(19) United States
(12) Patent Application Publication
(10) Pub. No.: US 2016/0303494 A1
(43) Pub. Date: Oct. 20, 2016

(54) LIQUID RECOVERY UNIT

(71) Applicant: ENVIRONMENTAL RECOVERY SOLUTIONS AND RENTAL, LLC, Coalgate, OK (US)

(72) Inventors: Larry O. Williams, Bokoshe, OK (US); Charles Horton, JR., Coalgate, OK (US)

(21) Appl. No.: 15/034,235

(22) PCT Filed: Jan. 6, 2015
(86) PCT No.: PCT/US15/10359

§ 371 Date: May 4, 2016

Related U.S. Application Data
(60) Provisional application No. 61/924,917, filed on Jan. 8, 2014.

(51) Int. Cl. B01D 21/24; B01D 21/00

(52) U.S. Cl. CPC B01D 21/245; B01D 21/0018; B01D 21/2416; B01D 21/0024

(57) ABSTRACT

A liquid recovery unit and method of operating the same useful in the recovery of spilled or leaked liquids. The unit utilizes a base attached to a receptacle. The base has a tank and pump mounted on it. The pump is used to pull a vacuum within the tank to thereby introduce the spilled liquids in the tank or to create a positive pressure within the tank to thereby remove liquids from the tank, or to remove solids from the tank into the receptacle.

### CROSS-REFERENCE TO RELATED APPLICATIONS

This application claims the benefit of U.S. Provisional Application No. 61/924,917 filed Jan. 8, 2013, which is hereby incorporated by reference.

### FIELD

The invention relates to a method and apparatus for recovery of liquids, typically spilled or leaked liquids. The invention is particularly applicable to the recovery of liquids, such as drilling fluids, which have been spilled or leaked on to well pads.

### BACKGROUND

In the drilling of oil and gas wells, liquids can be spilled on the ground or drill floor of the drill pad. Generally, these liquids can contain drilling fluids, also called drilling mud, and other hydrocarbons. Moreover, the drilling mud can include drill cuttings as well as additives introduced into the drilling mud. Additionally, by the contact with equipment, the ground or other surfaces, the spilled liquids can contain dirt and other solids. For environmental and safety reasons, it is desirable to collect these spilled liquids for safe disposal or for recycling for further use.

### SUMMARY

In one embodiment there is provided an apparatus for recovery of a liquid containing solids. The apparatus comprises a cuttings receptacle, a tank, a pump and a spout. The cuttings receptacle is mounted to a base. The tank has an upper portion and a lower portion. The tank is mounted to the base and has a lower position and an upper position wherein the tank is higher in the upper position than it is in the lower position. The pump is operationally connected to the tank such that the pump can introduce the liquid into the tank or remove the liquid from the tank. The spout is in communication with the lower portion of the tank. The spout is positioned over the solids receptacle such that solids, which settle to the lower portion of the tanks, can be removed from the tank through the spout and can be introduced into the solids receptacle through the spout.

Further, in the lower position, the tank can be folded down into the cuttings receptacle, and in the upper position, the tank can be, at least partially, above the cuttings receptacle. Also, the pump can be operationally connected to the tank such that the pump can produce a first pressure in the tank below ambient pressure, or a second pressure in the tank above ambient pressure.

The apparatus can further comprise a conduit in fluid flow communication with the tank. The conduit can be configured to introduce the liquid into the tank when the tank is at the first pressure and receive liquid from the tank when the tank is at the second pressure. Also, the apparatus can further comprise a manifold in fluid flow communication with the conduit. The manifold comprises a plurality of ports with each port having a valve controlling the fluid flow communication between the manifold and one or more hoses attached to the ports.

Additionally, the apparatus can further comprise a pneumatic valve operationally configured to control the flow of solids through the spout. Also, the upper portion of the tank can be cylindrical and the lower portion of the tank can be conical.

In another embodiment there is provided an apparatus for recovery of a liquid containing solids. The apparatus comprises a cuttings receptacle, a tank, a pump, a conduit and a spout. The cuttings receptacle is mounted to a base. The tank has an upper portion and a lower portion. The tank is mounted to the base. The pump is operationally connected to the tank such that the pump can produce a first pressure in the tank below ambient pressure, or a second pressure in the tank above ambient pressure. The conduit is in fluid flow communication with the tank. The conduit is configured to introduce the liquid into the tank when the tank is at the first pressure and receive liquid from the tank when the tank is at the second pressure. The spout is in communication with the lower portion of the tank. The spout is positioned over the solids receptacle such that solids, which settle to the lower portion of the tank, can be removed from the tank through the spout and can be introduced into the solids receptacle through the spout.

Further, the tank can have a lower position in which the tank is folded down into the cuttings receptacle and an upper position in which the tank is at least partially above the cuttings receptacle. Also, the apparatus can comprise a manifold in fluid flow communication with the conduit. The manifold comprises a plurality of ports with each port having a valve controlling the fluid flow communication between the manifold and one or more hoses attached to the ports. Additionally, the apparatus can comprise a pneumatic valve operationally configured to control the flow of solids through the spout. Further, the upper portion of the tank can be cylindrical and the lower portion of the tank can be conical.

In yet a further embodiment, there is provided a method for recovering a spilled liquid at a well site. The method comprises:
(a) positioning a base having a tank and a cuttings receptacle at a well site wherein the tank has an upper portion and lower portion;
(b) reducing the pressure within the tank to below ambient pressure such that the spilled liquid is introduced through a conduit into the tank through vacuum action, wherein the conduit is in fluid flow communication with the tank and wherein at least a portion of the spilled liquid contain solids;
(c) removing the thus introduced liquid from the tank to produce recovered liquids by increasing the pressure within the tank to above ambient pressure; and
(d) after step (c), removing solids within the tank, which settled out of the introduced liquid, through the lower portion of the tank.

Further in the method the solids can be removed from the tank in step (d) by increasing the pressure within the tank to above ambient pressure. Also, the spilled liquids comprise drilling fluid and the solids comprise drill cuttings.

Also, in the method, the tank can be in a lower position prior to step (a) and prior to step (b) the tank can be moved to an upper position wherein the tank is higher in the upper position than it is in the lower position. In the lower position the tank can be folded down into the cuttings receptacle, and in the upper position the tank can be at least partially above the cuttings receptacle. Additionally, the method can comprise moving the tank to its lower position after step (d) and subsequently moving the base to a different well site.

Further, in the method, a pneumatic valve can control the flow of solids through a spout. The spout can be in communication with the lower portion of the tank such that it can convey solids from the tank to the cuttings receptacle. Also, the solids can be removed from the tank in step (d) by increasing the pressure within the tank to above ambient pressure. The spilled liquid can comprise drilling fluid and the solids can comprise drill cuttings.

### BRIEF DESCRIPTION OF THE DRAWINGS

These and further features will be apparent with reference to the follow descriptions and drawings where:

FIG. 1 shows a side view of an embodiment wherein a tank is mounted upon a receptacle and includes a clean-out spout that empties into the receptacle.

FIG. 2 shows an end view of the embodiment of FIG. 1 wherein a pump and manifold can be seen in relation to the tank.

FIG. 3 is a sectional view taken along line 3-3 of FIG. 1

FIG. 4 is a partial sectional view taken along line 4-4 of FIG. 2. In FIG. 4 the receptacle is shown in cross-section and the tank is not. The tank is shown in its upper position.

FIG. 5 is a partial sectional view similar to FIG. 4 but with the tank shown in its lower position.

FIG. 6 is an illustration of a brake-away leg as attached to the base.

FIG. 7 is a view of the connectors for the break-away legs in the receptacle.

FIG. 8 is a view of one of the connectors of FIG. 7 with a leg attached.

### DESCRIPTION

In the description that follows, like parts are marked throughout the specification and drawings with the same reference numerals, respectively. The drawings are not necessarily to scale and in some instances the drawings have been exaggerated and/or simplified in places for illustrative purposes only. In the following description, the terms “upper,” “upward,” “lower,” “below,” and the like as used herein shall mean in relation to the natural orientation of the embodiment shown even though alternative embodiments may deviate from the orientation. The terms “inwardly” and “outwardly” are directions toward and away from, respectively, the geometric center of a referenced object. Where components of relatively well-known designs are employed, their structure and operation will not be described in detail.

Referring to the figures, one embodiment of a liquid recovery unit is illustrated. Generally, the liquids to recover can be liquids spilled during operations on oil and gas drilling rigs located on a well pad or during oil and gas recovery operations from wells located on a well pad. By spilled liquids it is meant liquids that have been spilled, have leaked or otherwise have pooled on the ground of the well pad or on other surfaces or equipment located on the well pad. The liquids will typically comprise hydrocarbons, drilling mud, drill cuttings and can contain dirt or other debris from equipment, the well pad or other surfaces. It should be understood that while especially advantageous for such use, the apparatus can be used in association with recovering other liquids and is especially useful in recovering liquids that may contain solids that will separate out in the tank of the apparatus.

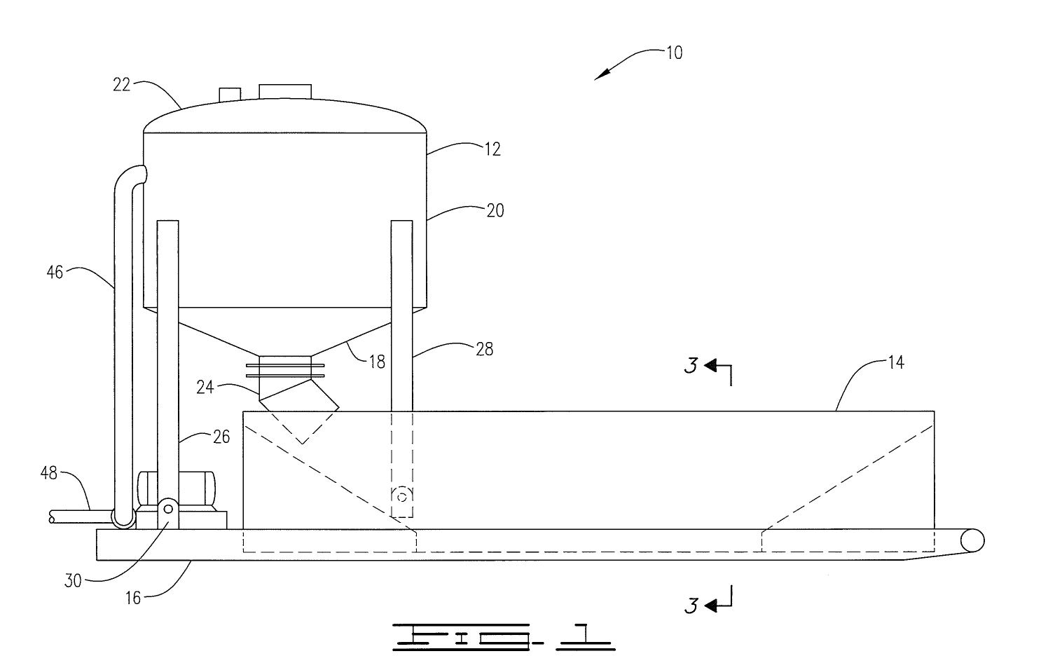

Referring to FIG. 1, the liquid recovery unit 10 can be seen to comprise a tank 12 and a receptacle 14 mounted on a base 18. The base 18 can be a skid, trailer or similar mount that allows the apparatus to be moved from well site to well site as a single unit. The receptacle 14 can be any suitable receptacle or vessel for containing solids removed from the recovered liquid. As illustrated, the receptacle is what is commonly known as a half-round pit or half-pit, which comprises a half cylinder with walls at each end. The tank 12 can be any suitable tank or vessel, but should be configured to support the separation and removal of solids, such as drill cuttings, from the recovered liquid. As illustrated the tank has a conical lower portion 18, a cylindrical upper portion 20 and domed top 22. The conical lower portion 18 facilitates separation and removal of solids through a spout 24 (further described below) while maintaining a greater proportion of liquid in the upper portion 20 of tank 12 than in lower portion 18. The tank can be a large capacity tank. Typically, the tank will have a capacity of holding from 80 to 100 barrels or more of material.

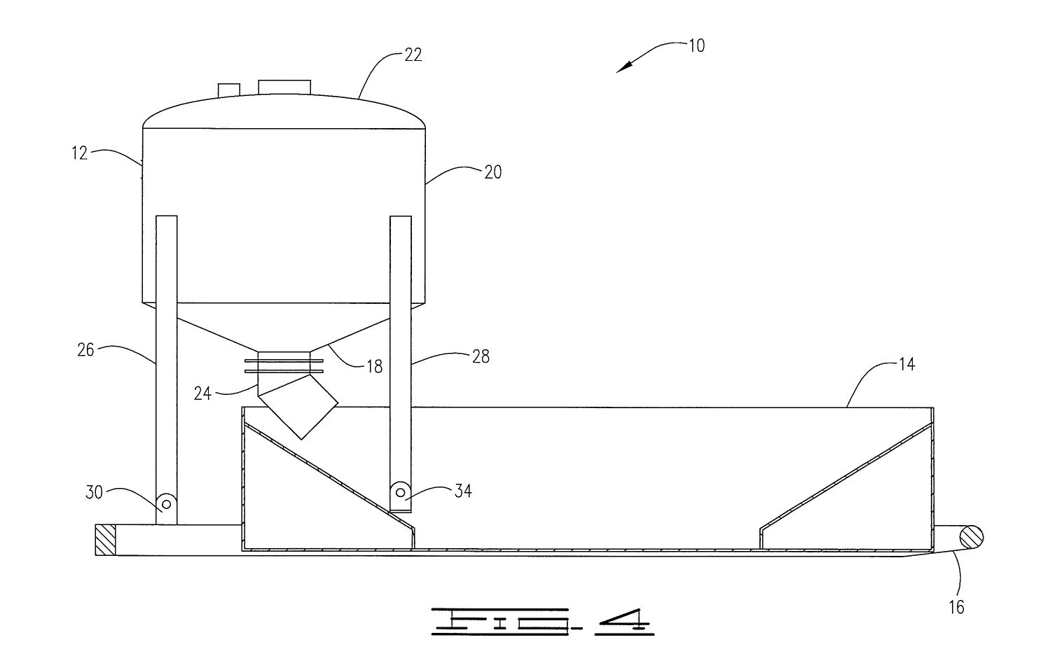

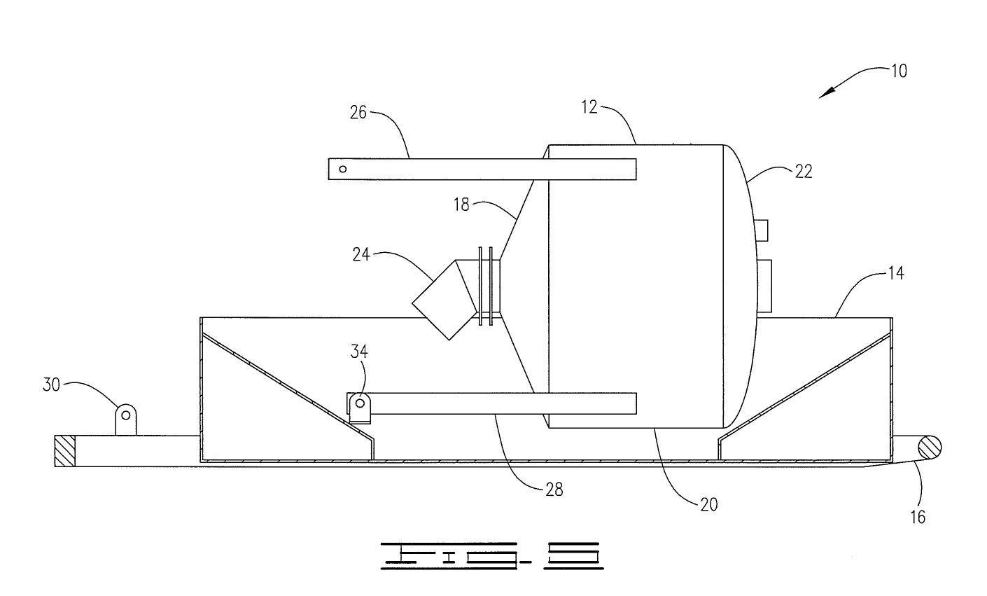

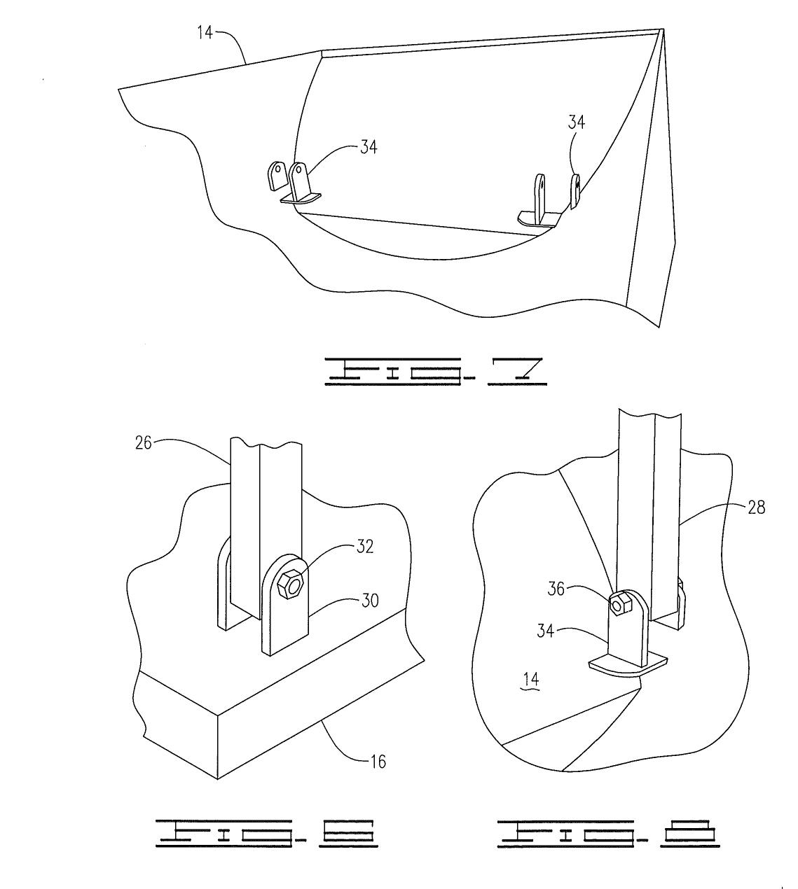

The tank 12 is mounted to the base 16 by collapsible legs 26, 28, which allow the lowering of the tank 12 to facilitate transportation of the liquid recovery unit 10. In the illustrated embodiment, the tank 12 is mounted to the base 16 by front legs 26, which are outside the half-pit 14 and rear legs 28 that extend into the half-pit 14. As can best be seen from FIG. 6, each front leg 26 is releasably mounted to the base 16 by means of a bracket 30 and a connector 32. Connector 32 is illustrated as a nut-and-bolt assembly but can be any suitable connector, for example a pin assembly. The connector 32 engages the bracket 30 and front leg 26 through apertures in each to securely lock front leg 26 in position; however, by removal of connector 32 the front leg 26 is unlocked from the bracket. As can be seen from FIGS. 7 and 8, the rear legs 28 are pivotally mounted to the half-pit or receptacle 14 by a pivotal-connector assembly. As illustrated, the pivotal-connector assembly comprises a bracket 34 and a nut-and-bolt assembly 36 but can be bracket-and-pin assembly, a hinge or any similar means as long as rear legs 28 are capable of pivoting about the connector so that, when the front legs 26 are unlocked from the brackets 30, the tank 12 can be moved between a first or lower position, wherein the tank is folded down over receptacle 14 or folded down into and received within receptacle (FIG. 5), and a second or upper position, wherein the tank is positioned at least partially over the receptacle 14 with spout 12 positioned over and/or in receptacle 14 so that solids can be introduced into receptacle 14 (FIG. 4). It will be appreciated that the front legs 26 only engage the brackets 30 in the second position. Generally, the tank 12 will have a diameter at least slightly smaller than the diameter of the receptacle 14 so as to be received in the receptacle 14 in the first position.

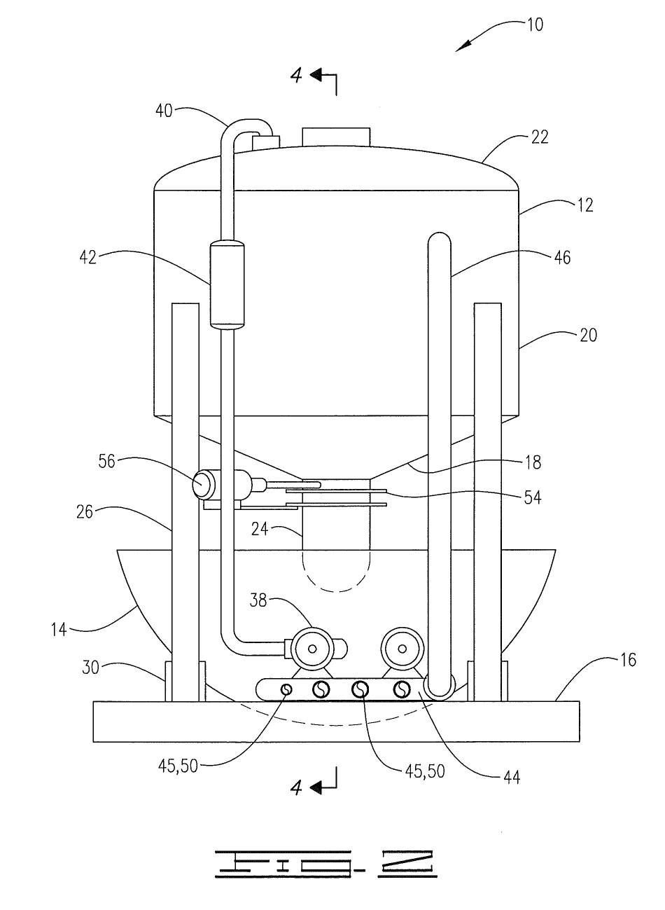

Turning now to FIG. 2, the pump and manifold system of the current embodiment can be seen and is located on the base 16 of the liquid recovery unit 10. The pump 38 is configured and operationally connected to the tank 12 such that, in a first setting, the pump can produce a first pressure in the tank 12 below ambient pressure and, in a second setting, can produce a second pressure in the tank 12 above ambient pressure.

As can be seen from FIG. 2, a pump hose or conduit 40 is in fluid flow communication with both the pump 38 and the top domed portion 22 of the tank 12. Conduit 40 can have a trap or filter 42 in its line to remove liquids or solids that might exit tank 12 through line 40. Additionally, a manifold 44 is in fluid flow communication with the tank 12. Typically, the manifold 44 is in fluid flow communication with the tank 12 via a manifold hose or conduit 46. Manifold hose 46 is typically in fluid flow communication with the tank 12 at cylindrical upper portion 20. Also, one or more suction hoses or conduits 48 (FIG. 1) can be attached to the manifold at one or more ports 45 through one or more hose connectors, such as quick connect adapters. The flow through each hose connector can be controlled by a valve 50, which can be set to an on position to allow flow or an off position to prevent flow between the suction hose 48 and the manifold 44. The manifold 44, manifold hose 46 and suction hoses 48 are configured to introduce fluid into the tank when the tank 12 is at the first pressure and receive liquid from the tank when the tank is at the second pressure. Generally, the pump will be high-powered pump capable of creating 20 psi or greater of pressure. Typically the pump will be capable of creating at least 30 psi of pressure.

The first and second settings of the pump 38 can be configured by switchable conduits between the pump 38 and the tank 12; however, in one embodiment the pump is a reversible pump 38 so that in a first setting the pump 38 operates to withdraw a first fluid (typically air) from the tank 12 through the pump hose 40 and in a second setting the pump 38 operates to introduce the first fluid (typically air) into the tank 12 through the pump hose 40. In other words, in the first setting the pump 38 pulls a vacuum to generate the first pressure in the tank 12. That is, it creates a pressure differential between the inside of the tank 12 and the surrounding environment outside the tank 12 such that the inside of the tank is at a first pressure substantially below the pressure of the surrounding environment (“ambient pressure”) so that a second fluid is drawn into and through one or more of the suction hoses 48 and then through the manifold 44 and the manifold hose 46 into the tank 12. Generally, for drilling rig operations the second fluid will be spilled liquids such as drilling mud. In its second setting, the pump 38 pressures up or blows the first fluid into the tank 12 to generate the second pressure in the tank 12. That is, it creates a pressure differential between the inside of the tank 12 and the surrounding environment outside the tank such that the inside of the tank 12 is at a pressure substantially above the ambient pressure so that second fluid within the tank 12 is pushed out of the tank into and through manifold hose 46 and manifold 44 and then through one or more of the suction hoses 48. Additionally, such a positive pressure differential may be created so that solids are pushed out of the spout 24, as further described below.

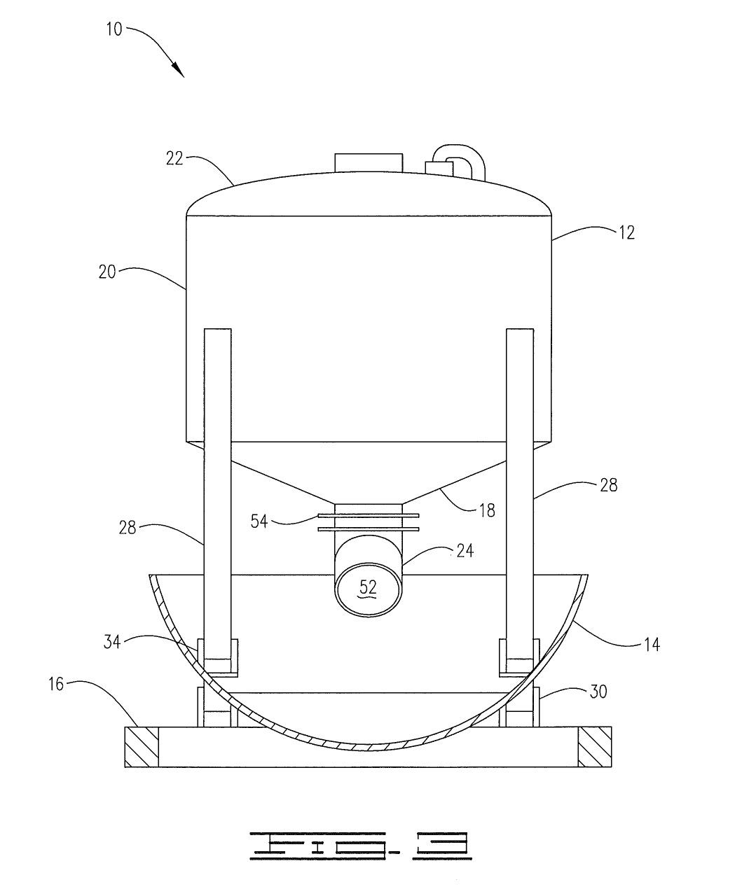

Turning now to FIGS. 2 and 3, the clean-out spout or tube 24 of the current embodiment can be seen. The clean-out spout 24 is in communication with the bottom of the conical lower portion 18 of the tank 12 such that solids can be introduced from the conical lower portion into the spout 24 and exit the spout 24 through an end aperture 52 to be introduced into the half-pit 14. Flow through the spout 24 is controlled by a valve 54, which is typically a pneumatic valve. The valve 54 has a first position which allows flow from lower conical portion 18 through the spout 24 and a second position that prevents flow from lower conical portion 18 through the spout 24. If a pneumatic valve, the valve 54 can be moved from its first position to its second position by a pneumatic motor 56 which receives air, or another activating gas, through a distributor (not shown).

In operation, the illustrated embodiment of the liquid recovery unit 10 is transported to a first well pad or rig site in its first or lower position wherein the tank is folded down into the cuttings receptacle. At the first well pad or rig site, the liquid recovery unit 10 is unloaded with the base set on the ground. Once the base of the liquid recovery unit is set in position, the tank is moved to its second or upper position where the tank is at least partially above the cuttings receptacle 14 such that spout 12 extends into and/or over receptacle 14. Front legs 26 are connected to bracket 30 and manifold hose 46 and pump hose 40 can be connected, as necessary. The first end of each suction hose 48 can be connected to the manifold 44 via the hose connectors. The associated valves 50 of each hose connector can be moved to its open or closed position as desired depending on whether that hose connector will be used to receive spilled liquids. The pump 38 is then activated in its first setting so that a vacuum is pulled within the tank 12 and, hence, the pressure within the tank 12 is reduced such that liquids are pulled or introduced into the tank through the suction hoses 48, manifold 44 and manifold hose 46. Thus, spilled liquids are collected in the tank by moving a second end of the suction hose around to different areas of the well pad where liquids have collected. Typically, these will be liquids containing solids as previously described.

Once substantially all the liquids have been collected in the tank 12 or the tank 12 is substantially full, the liquids can be removed from the tank 12 and introduced into a tanker truck for removal from the site or introduced into a storage tank. Removal is accomplished by connecting the second end of the suction hose to the storage tank or tanker truck and reversing the pump operation so that it is in its second setting. Thus, the pressure within the tank 12 is increased such that liquids are pushed from the tank 12 through the manifold hose 46, the manifold 44 and one or more of the suction hoses 48 and introduced into the storage tank or tanker truck. During its residence within the tank 12, solids in the recovered liquids will settle out of suspension and fall into the conical lower portion 18 or bottom of the tank 12. After removal of a portion of the recovered liquids and, typically, after removal of substantially all the recovered liquids, the valve 54 associated with the spout 24 is moved from a closed position to an open position and solids are allowed to move from the lower conical portion 18 of the tank 12 into the half-pit 14. In one embodiment, the movement of the solids is facilitated by the positive pressure in the tank 12 created by the pump in its second setting. In order to so facilitate the movement, control valves 50 on manifold 44 can be closed so as to prevent air from exiting through the manifold 44.

After completion of removal of the liquids from the first well pad or rig site, the pump hose 40 and manifold hose 46 can be disconnected so as not to interfere with the movement of tank 12 to its first or lower position. Front legs 26 are then disconnected from brackets 30 and tank 12 is moved to its first or lower position, down into receptacle 14. Liquid recovery unit 10 can then be loaded onto a truck or trailer and moved to a second well pad or rig site for further use.

Other embodiments of the current invention will be apparent to those skilled in the art from a consideration of this specification or practice of the invention disclosed herein. Thus, the foregoing specification is considered merely exemplary of the current invention with the true scope thereof being defined by the following claims.

What is claimed is:

1. An apparatus for recovery of a liquid containing solids, said apparatus comprising:
a cuttings receptacle mounted to a base;
a tank having an upper portion and a lower portion, wherein said tank is mounted to said base and has a lower position and an upper position wherein said tank is higher in said upper position than it is in said lower position;
a pump operationally connected to said tank such that said pump can introduce said liquid into said tank or remove said liquid from said tank; and
a spout in communication with said lower portion of said tank, said spout positioned over said solids receptacle such that solids, which settle to said lower portion of said tank, can be removed from said tank through said spout and can be introduced into said solids receptacle through said spout.

2. The apparatus of claim 1 wherein in said lower position said tank is folded down into said cuttings receptacle and in said upper position said tank is at least partially above said cuttings receptacle.

3. The apparatus of claim 1 said pump is operationally connected to said tank such that said pump can produce a first pressure in said tank below ambient pressure, or a second pressure in said tank above ambient pressure.

4. The apparatus of claim 3 further comprising a conduit in fluid flow communication with said tank, wherein said conduit is configured to introduce said liquid into said tank when said tank is at said first pressure and receive liquid from said tank when said tank is at said second pressure.

5. The apparatus of claim 4 further comprising a manifold in fluid flow communication with said conduit wherein said manifold comprises a plurality of ports with each port having a valve controlling said fluid flow communication between said manifold and one or more hoses attached to said ports.

6. The apparatus of claim 1 wherein further comprising a pneumatic valve operationally configured to control the flow of solids through said spout.

7. The apparatus of claim 1 wherein said upper portion of said tank is cylindrical and said lower portion of said tank is conical.

8. An apparatus for recovery of a liquid containing solids, said apparatus comprising:
a cuttings receptacle mounted to a base;
a tank having an upper portion and a lower portion, wherein said tank is mounted to said base;
a pump operationally connected to said tank such that said pump can produce a first pressure in said tank below ambient pressure, or a second pressure in said tank above ambient pressure;
a conduit in fluid flow communication with said tank, wherein said conduit is configured to introduce said liquid into said tank when said tank is at said first pressure and receive liquid from said tank when said tank is at said second pressure; and
a spout in communication with said lower portion of said tank, said spout positioned over said solids receptacle such that solids, which settle to said lower portion of said tank, can be removed from said tank through said spout and can be introduced into said solids receptacle through said spout.

9. The apparatus of claim 8 wherein said tank has a lower position in which said tank is folded down into said cuttings receptacle and an upper position in which said tank is at least partially above said cuttings receptacle.

10. The apparatus of claim 9 further comprising a manifold in fluid flow communication with said conduit wherein said manifold comprises a plurality of ports with each port having a valve controlling said fluid flow communication between said manifold and one or more hoses attached to said ports.

11. The apparatus of claim 10 wherein further comprising a pneumatic valve operationally configured to control the flow of solids through said spout.

12. The apparatus of claim 11 wherein said upper portion of said tank is cylindrical and said lower portion of said tank is conical.

13. A method for recovering a spilled liquid, which contains solids, at a well site comprising:
(a) positioning a base having a tank and a cuttings receptacle at a well site wherein said tank has an upper portion and lower portion;
(b) reducing the pressure within said tank to below ambient pressure such that said spilled liquids is introduced through a conduit into said tank through vacuum action, wherein said conduit is in fluid flow communication with said tank and wherein at least a portion of said spilled liquids contains solids;
(c) removing said thus introduced liquid from said tank to produce recovered liquids by increasing the pressure within said tank to above ambient pressure; and
(d) after step (c), removing solids within said tank, which settled out of said introduced liquid, through said lower portion of said tank.

14. The method of claim 13 wherein said solids are removed from said tank in step (d) by increasing the pressure within said tank to above ambient pressure.

15. The method of claim 13 wherein said spilled liquids comprise drilling fluid and said solids comprise drill cuttings.

16. The method of claim 13 wherein said tank is in a lower position prior to step (a) and prior to step (b) said tank is moved to an upper position and wherein said tank is higher in said upper position than it is in said lower position.

17. The method of claim 16 wherein in said lower position said tank is folded down into said cuttings receptacle and in said upper position said tank is at least partially above said cuttings receptacle.

18. The method of claim 17 further comprising moving said tank to its lower position after step (d) and subsequently moving said base to a different well site.

19. The method of claim 18 wherein a pneumatic valve controls the flow of solids through a spout and wherein said spout is in communication with said lower portion of said tank such that it can convey solids from said tank to said cuttings receptacle.

20. The method of claim 19 wherein said solids are removed from said tank in step (d) by increasing the pressure within said tank to above ambient pressure and wherein said spilled liquids comprise drilling fluid and said solids comprise drill cuttings.
